(19) United States
(12) Patent Application Publication
(10) Pub. No.: US 2010/0254878 A1
(43) Pub. Date: Oct. 7, 2010

(54) PROCESS FOR WINNING PURE SILICON

(76) Inventors: Armin MÜLLER, Freiberg (DE); Christian Kusterer, Freiberg (DE); Silvio Stute, Freital (DE); Martin Bertau, Freiberg (DE); Ute Singliar, Grossschirma (DE); Robert Schulze, Kriftel (DE); Edwin Kroke, Freiberg (DE); Hans-Joachim Möller, Freiberg (DE)

Correspondence Address: MCGLEW & TUTTLE, PC, P.O. BOX 9227, SCARBOROUGH STATION, SCARBOROUGH, NY, 10510-9227, US

(21) Appl. No.: 12/752,473

(22) Filed: Apr. 1, 2010

(30) Foreign Application Priority Data
Apr. 2, 2009 (DE) 10 2009 016 014.0

(51) Int. Cl. C01B 33/02; B01D 15/00

(52) U.S. Cl. 423/348; 210/198.1

(57) ABSTRACT

Process for winning pure silicon comprising the following steps: Providing a suspension, which exhibits at least some contaminated silicon particles, and guiding the suspension through at least one microstructure apparatus.

### FIELD OF THE INVENTION

The invention relates to a process for winning pure silicon and to a plant for performing said process.

### BACKGROUND OF THE INVENTION

Silicon of a high purity is required in photovoltaics, e.g. for the production of solar cells. Silicon of such a purity is referred to as solar-grade silicon (sg-Si).

The sg-Si is typically produced via known large-scale processes. For further processing it is cast into blocks, so-called ingots. The ingots are sawn into columns or wafers, e.g. by means of wire saws. The silicon kerf, the saw dust of the silicon, accumulating during this is contaminated with the parts rubbed off the saw wire and cannot therefore be used for photovoltaic purposes without prior cleaning steps. Known processes for cleaning silicon are very elaborate.

### SUMMARY OF THE INVENTION

The object of the invention is therefore to provide a more low-cost process for winning pure silicon, especially sg-Si. It is also an object of the invention to create a plant for performing such a process.

Said object is achieved by the features of the invention. The core of the invention consists in guiding silicon particles as a suspension through a reaction channel of a microstructure apparatus.

Such microstructure apparatuses are low in cost to acquire, easy to operate and occupy comparatively little space. They can be operated continuously, it being possible to process the silicon kerf directly and introduce it back in to the raw material stream.

Microstructure apparatuses are characterised by reactor dimensions of ≦1,000 μm, through which there is brought to bear, with the diffusion control of the material transport, a property of the microscale that is characteristic of the conventional macro-scale reactor. The disadvantages of the interplay of adsorption and desorption of the foreign atoms from the grain surface occurring during the macro-scale leaching are bypassed in the microstructure apparatus. The leaching behaviour is dominated by the high concentration gradient between the grain surface and the selective phase and the diffusion-controlled, fast evacuation of the foreign atoms from the phase boundary surface. The influence of the competing back-diffusion and adsorption to the grain surface is minimised by short residence times. Additional advantages inextricably linked with the microstructure apparatus result from the compartmentation of the residence track by means of an inert phase (slug flow), through which selectivity losses through backmixing are avoidable. The advantage of this approach consists in the almost identical composition of each segment for a given position on the residence track, with which defined product qualities can be set.

Microstructure apparatuses allow the solution of the extraction problem via sequential foreign atom depletion under different conditions, which are adapted individually to the relevant foreign atom contamination. An exhaustive depletion of all foreign atom contaminations in a single step cannot normally be realised. In this manner, by connecting in series several microstructure apparatuses, efficiency enhancements in terms of the selective foreign atom depletion can be accomplished via leaching processes in microstructures. Of particular interest here is the isothermal quenching of the acidic or basic selective phase, because the high surface/volume ratio of the microstructure apparatuses allows a highly efficient removal of heat.

However, an essential advantage of the microstructure apparatuses is not only the realising of the specific conditions required for the leaching of each contamination via a connection in series of micro-extractors, but also the continuous process control. Macro-scale reaction systems are typically only poorly suited for the selective setting of defined foreign atom levels. This relates in particular to batch reactors, which are unsuited not only because of the foreign atom accumulation occurring therein and the related concentration-dependent foreign atom adsorption to the grain surface, but also because of the discontinuous mode of operation, through which the process can become economically unattractive. Above all, however, in the case of continuous operation, silicon particles of a similar geometry can be used in the microstructure apparatus and be retained on the product side because under these conditions, there is no residence time-dependent material removal as in the volume phase of batch reactors but a passing through identical reaction conditions of all fluid packages within the residence track of the microstructure apparatus. What's more, because of the continuous process control, storage losses e.g. though oxidation or corrosion are avoided.

The silicon recycled in accordance with the process can be pressed and/or molten without any further intermediate steps and be processed further for photovoltaic purposes.

Foreign atoms contained in the silicon are preferably depleted as they are guided through the microstructure apparatus by means of leaching of the particles with at least one leaching agent.

### BRIEF DESCRIPTION OF THE DRAWING

FIG. 1 shows the process sequence according to the invention as a flow diagram.

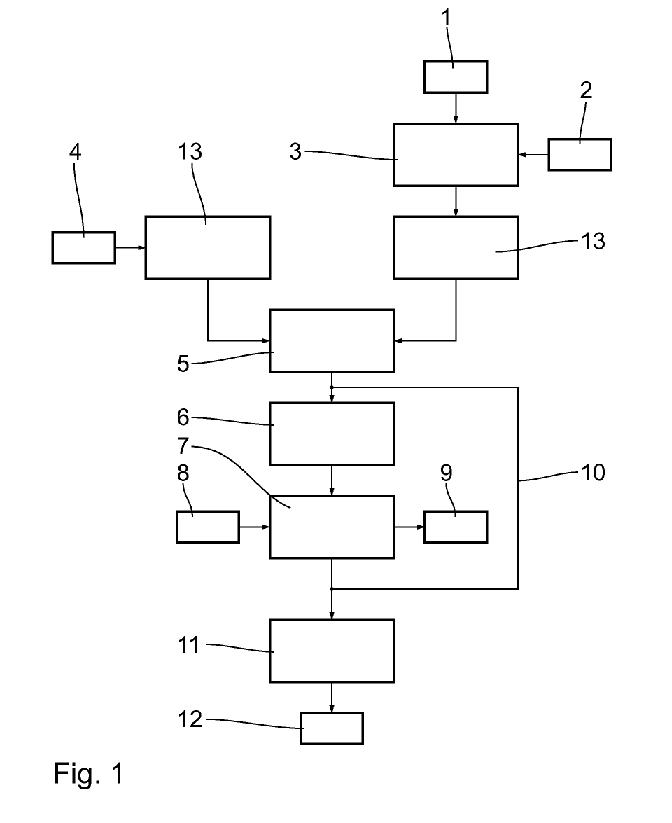

### DESCRIPTION OF THE PREFERRED EMBODIMENT

Silicon kerf 1 is dispersed with a suspending agent 2 in a vessel 3 also referred to as a slurry producer with the aid of thermal and/or ultrasound-cavitative effects into a suspension. The suspension is conveyed alongside a leaching agent 4 via pumps 13 into a mixer 5. From the mixer 5 the suspension is conveyed into a microstructure apparatus 6. From the feeding point a plurality of microstructure apparatuses 6 distribute themselves in the shape of a star. They are arranged in parallel to each other and/or sequentially behind each other. The cascade of the microstructure apparatuses 6 consists of polyethylene (PE) or polytetrafluoroethylene (PTFE) material. The microstructure apparatuses 6 are temperature-controlled by the environment. After the bringing together of the material flows, the etched silicon is continuously separated from the leaching agent 4 and the dissolved constituents 9 in a centrifuge and/or a hydrocyclone 7. Depending on the leaching agent 4 used, there may be envisaged a wash through re-dispersion of the etched silicon with a washing agent 8 and subsequent solid-liquid separation. It may be envisaged to guide the suspension in several passes 10 through the microstructure apparatuses 6 until the desired purity has been reached. In order to remove the residual humidity or evaporable foreign components of the final product, there follows at the end of the process chain, i.e. after the last guiding through of the suspension through the microstructure apparatuses 6, a vacuum thermal drying step under inert conditions. For the drying there is especially envisaged a filter dryer, a fluidised bed dryer, a venturi dryer, a cryoscopic or an extraction dryer. The target product 12 is obtained as a pre-compacted, fine-particle material, especially silicon powder.

In the following the features and details of the process according to the present invention are once again described in detail. First, a suspension, which exhibits at least some silicon particles, is provided. Said suspension is guided through a microstructure apparatus 6 for the cleaning of the silicon particles.

In the following, the term “microstructure apparatus” is to be understood as referring to micro-reactors exhibiting a reaction channel with a diameter in the micro-scale range, i.e. below 2000 μm, preferably in the range between 2000 μm and 5 μm, especially preferably in the range between 500 μm and 30 μm. Structures of this order of magnitude are also referred to as “microstructures”. Here, the length of the microstructures, for example that of the reaction channel, is in the range of several centimetres to more than 100 metres.

Microstructure apparatuses 6 suitable for the process according to the invention are known to the expert e.g. from G. Emig, E. Klemm, Technische Chemie, 5th current edition, Springer-Verlag, Heidelberg, 2005, ISBN 3-50-23452-7.

The suspension is especially a fine suspension, i.e. the silicon particles exhibit a medium grain size of less than 50 μm, preferably a medium grain size in the range of 0.1 μm to 30 μm, especially preferably in the range of 0.3 μm to 20 μm. This enables the subsequent use of microstructure apparatuses 6. Here, medium grain size is to be understood as meaning that at least 50 percent of the particles have a grain size less than or equal to the value specified.

According to the invention the suspension is won from silicon kerf accumulating during the sawing of silicon ingots. However, the silicon particles may also stem from other processing or production process of semiconducfor or solar silicon, e.g. other sawing, grinding or milling processes as well as sorting or filtering processes. Here, sawing water is used as a coolant/lubricant for the cutting technology, and where SiC is used as an abrasive agent, the wire is flushed and cooled with glycol or oil during the sawing. The suspension therefore exhibits some coolant and/or lubricant from the sawing water, especially glycol and/or oil. In the initial state, the silicon particles are contaminated with the rubbed-off parts of the sawing blade or wire. In the initial state, they therefore exhibit contamination with metals and/or oxygen.

An exemplary composition of the suspension for aqueous cutting is around 99% water and 1% solid material, which in turn consists of about 99% Si and residual metallic rubbed-off parts such as iron (Fe) or copper (Cu). The starting material can also be a used slurry, which consists, for example, of about 25% polyethylene glycol and 75% solids, which in turn consists of about 12% metallic rubbed-off parts, including Fe and/or Cu, 13% Si, 74% SiC and 1% glass. The silicon particles in this mixture must be isolated from the non-elemental Si— or foreign substances in order to be used in the process described here.

A contamination of the silicon particles caused by the aforementioned processing methods and processes, especially with metallic contaminants, is reduced in an appropriate way to values in accordance with the specification. The possibility of recycling the corresponding silicon fines improves the economic and ecological footprint.

The extraction material is guided through the reaction channel as a suspension, during which, because of the small reactor dimensions, there is no material transport perpendicular to the direction of transfer and no backmixing. Thus, identical reaction conditions are ensured along the reaction path. This way it is possible to retain silicon particles which exhibit largely identical foreign atom depletion rates. Through this, it is possible to achieve the high degree of purity required. It may be envisaged that the suspension is guided several times, i.e. repeatedly, through the microstructure apparatus 6. It is especially guided through the microstructure apparatus 6 so often until the silicon particles exhibit a certain purity, especially at least solar-grade, preferably electronic-grade purity. Solar-grade purity here is understood as silicon with contaminants of less than 10⁻⁷ (100 ppb), electronic-grade purity is understood as silicon with contaminants of less than 10⁻¹¹ (0.01 ppb).

Before it is guided through the microstructure apparatus 6, the suspension is mixed with a leaching agent 4 for the depletion of foreign atoms. As leaching agent 4 there is preferably used at least one acid and/or base. Acids preferably envisaged are HF, HNO₃, H₂SO₄ or HCl. Bases preferably used are KOH, NaOH or NH₄OH. The acid and/or base is used in a concentrated form or as an aqueous solution, the leaching agent 4 being used individually or in combinations of two or a plurality of the mentioned leaching agents 4. Known and customary concentrations and mixing ratios may be used here.

Leaching is preferably carried out at a temperature of 10° C. to 250° C., preferably at 20° C. to 100° C., especially preferable at 20° C. to 50° C. According to experience, the required exposure time of the leaching agents 4 can often be reduced considerably by increasing the temperature.

Leaching preferably takes place in a pressure range of normal pressure to 100 bar gauge pressure, preferably in a pressure range of 0.1 bar to 30 bar, especially to 10 bar gauge pressure. This is advantageous especially for long microstructure apparatuses 6, in which a pressure drop of several bar occurs over a length of 100 m.

Leaching preferably takes place under semi-continuous, especially under continuous conditions, i.e. the suspension is guided through the reaction channel of the microstructure apparatus 6 in a semi-continuous, especially in a continuous manner. This way, an economic mode of operation is achieved.

Foreign atom depletion thus occurs via leaching processes. By varying the pressure and temperature, the contaminants are selectively depleted. The leaching agent 4 used or the sequence of the leaching agents 4 used and/or their mixture normally depends on the contaminants to be removed. Preferably at least two, especially a plurality of microstructure apparatuses 6 may also be envisaged sequentially behind each other.

After running through the microstructure apparatus 6, the suspension is again separated from the leaching agent 4. For this there is especially envisaged a continuous separation process. The suspension is especially filtered and/or centrifuged. It may also be washed with a washing agent.

Thereafter, a vacuum-thermal drying step for drying the silicon particles under inert conditions is envisaged. For drying there is especially envisaged a filter dryer, a fluidised bed dryer, a venturi dryer, a cryoscopic or an extraction dryer.

Owing to the micro-scale dimensions of the microstructures, the material transport in the microstructure apparatus 6 is diffusion-controlled and unlike convective material transport in conventional macro-scale reactor systems it is by up to two orders of magnitude faster. As a result, the foreign atom extraction through leaching in the microstructure apparatus 6 is much more effective than in conventional macro-systems. Especially metallic contaminations or oxidised surfaces, i.e. contaminations with oxygen, can be removed from the described fine silicon particles or be minimised through appropriate leaching agents 4, without the metallic silicon quantity being significantly reduced. Surprisingly, it has been found that unlike the conventional technology this can be implemented in the microstructure apparatus 6.

Preferably at least two, especially a plurality of microstructure apparatuses 6 are operated in parallel. The high degree of parallelisation of individual microstructure apparatuses 6 allows the synthesis of the sg silicon on a technical scale. Advantageously, the reaction processes do not have to be newly optimised here, but the process parameters determined from the laboratory scale on a single microstructure apparatus 6 can be taken over directly.

As a result of the process according to the invention, the achieved chemical composition of the silicon particles is homogeneous, thanks to which the obtained sg-Si particles can, after the leaching, be compacted directly into sg-Si particles that are mature for application. For this, the particles are preferably press-compacted and/or molten.

The process according to the invention allows the low-cost and easy recycling of solar-grade silicon or electronic-grade silicon from originally solar-grade or electronic-grade silicon contaminated by manufacturing processes.

What is claimed is:

1. A process for winning pure silicon comprising the following steps:
providing a suspension, which exhibits at least a fraction of contaminated silicon particles,
guiding the suspension through at least one microstructure apparatus (6) to clean the silicon particles.

2. A process according to claim 1, wherein the suspension is a fine suspension, the silicon particles exhibiting especially a medium grain size of less than 50 μm.

3. A process according to claim 1 wherein the suspension is won from silicon kerf accumulating during the treatment of silicon ingots.

4. A process according to claim 1, wherein the silicon particles exhibit, in the in the initial state, contaminations with at least one of metals and oxygen.

5. A process according to claim 1, wherein for the depletion of foreign atoms the suspension is mixed with at least one leaching agent (4) prior to the guiding though the at least one microstructure apparatus (6).

6. A process according to claim 5, wherein after the guiding though the at least one microstructure apparatus (6) the suspension is separated from the leaching agent (4).

7. A process according to claim 1, wherein after the guiding though the at least one microstructure apparatus (6) the suspension is filtered.

8. A process according to claim 1, wherein the suspension is repeatedly guided through the at least one microstructure apparatus (6).

9. A process according to claim 8, wherein the suspension is guided so often through the at least one microstructure apparatus (6) until the silicon particles exhibit a certain purity.

10. A process according to claim 9, wherein the suspension is guided so often through the at least one microstructure apparatus (6) until the silicon particles exhibit a certain solar grade purity.

11. A process according to claim 9, wherein the suspension is guided so often through the at least one microstructure apparatus (6) until the silicon particles exhibit a certain electronic grade purity.

12. A process according to claim 5, wherein at least one acid is envisaged as a leaching agent (4).

13. A process according to claim 5, wherein at least one of the group of HF, HNO₃, HCl and H₂SO₄ and a base is envisaged as a leaching agent (4).

14. A process according to claim 5, wherein the base is at least one of KOH, NaOH and NH₄OH.

15. A process according to claim 1, wherein the suspension, while being guided through the at least one microstructure apparatus (6), is brought to a temperature in the range of 10° C. to 250° C.

16. A process according to claim 1, wherein the suspension, while being guided through the at least one microstructure apparatus (6), is brought to a temperature in the range of 20° C. to 100° C.

17. A process according to claim 1, wherein the suspension, while being guided through the at least one microstructure apparatus (6), is brought to a temperature in the range of 20° C. to 50° C.

18. A process according to claim 1, wherein the suspension, while being guided through the at least one microstructure apparatus (6) for leaching, is brought to a pressure in the range of normal pressure to 100 bar gauge pressure.

19. A process according to claim 1, wherein at least two microstructure apparatuses (6) are envisaged at least one of in parallel to each other and sequentially behind each other.

20. A process according to claim 1, wherein after having been guided through the at least one microstructure apparatus (6) the silicon particles are dried.

21. A process according to claim 1, wherein after leaching, the cleaned silicon particles are at least one of press-compacted and molten.

22. A plant comprising
means (13, 5) for mixing a suspension with a leaching agent (4) and
at least one microstructure apparatus (6).
